(19) United States
(12) Patent Application Publication
(10) Pub. No.: US 2023/0224184 A1
(43) Pub. Date: Jul. 13, 2023

(54) Power Cutoff Message Handling

(71) Applicant: Schreder S.A., Bruxelles (BE)

(72) Inventors: Robert Link, Liège (BE); Oskar Piechowski, Liège (BE)

(21) Appl. No.: 18/001,431

(22) PCT Filed: Jun. 10, 2021
(86) PCT No.: PCT/EP2021/065647

§ 371 Date: Dec. 9, 2022

(30) Foreign Application Priority Data
Jun. 10, 2020 (NL) 2025801

(51) Int. Cl. H04L 12/28; H04L 67/125

(52) U.S. Cl. CPC H04L 12/2816; H04L 67/125; H04L 12/2809

(57) ABSTRACT

Set of devices adapted to form a local network (3), the set comprising at least one first communication device (1) and multiple second communication devices (2), wherein the first and the second communication devices comprise a short-range communication module (4) to communicate in the local network (3) via a hopping mechanism, and wherein the first communication device additionally comprises a long-distance communication module (5) to communicate with a remote server (6), wherein each one of the second communication devices (2) comprises a memory adapted to store a hopping distance to the first communication device wherein the second communication device is configured to execute actions based on said hopping distance in said power cutoff mode.

The present invention relates to a set of devices adapted to form a local network and to a method for operating a communication device in a local network.

In particular, the set of devices and the method relate to a local network formed by a set of devices, the set comprising at least one first communication device and at least one second communication device, wherein both the first and the second communication devices comprise a communication module to communicate in the local network via a hopping mechanism, and wherein the first communication device additionally comprises a further communication module to communicate with a remote server. The communication module to communicate in the local network via a hopping mechanism is preferably a short-range communication module. The further communication module to communicate with the remote server is preferably a long-distance communication module. To avoid any misunderstanding in this description, the terms short-range communication module and long-distance communication module will be used to distinguish between the communication module and the further communication module. It will be clear that this terminology is not used to define or limit the communication modules, but rather used as a linguistic choice to distinguish between the communication module and the further communication module. The technical features defining the communication module are related to its use, which is to communicate in the local network via a hopping mechanism. In other words, the technical features defining communication module are chosen to enable the module to form a mesh or star topology network. The technical features defining the further communication module are related to its use, which is to communicate with a remote server.

Such set of devices is commonly used to form local communication networks with a mesh topology or a star topology. Such local network is used for example to control an outdoor lighting system. Via the local network, luminaires in the outdoor lighting system can be controlled by a central management system. The central management system allows an operator to set static and/or dynamic controls for the luminaires Static controls define a behavior of the luminaire over time. Dynamic controls define the output of the luminaire in relation to obtained data and/or time. Obtained data is defined as at least one of received data, measured data, sensor data and pre-programmed data. In any case, independent of the configuration, it is considered to be an advantage when the operator can retrieve the actual status of each luminaire at each moment in time. The actual status is not necessarily just the on/off info but could also include additional info such as electricity consumption, dimming status at the moment just before the power was cut off, . . . .

Tests have shown that when devices in the local network loose connection, the status of the luminaire is not updated at the remote management server and the operator cannot retrieve the most recent status of the luminaire. This becomes more problematic when the local network has not yet detected that communication is lost. In the latter situation, the local network management system indicates the previous status of the luminaire as the current status, which is incorrect in most situations. A local network is defined as a network extending over a limited physical area, for example a city, a building, a company premise, etc.

Although embodiments of the invention are conceived in relation to the luminaire networks, the underlying problem and corresponding solution are also relevant for other than luminaire networks. In general, internet-of-things (IoT) networks provide a communication mechanism for smart devices allowing these devices to be controlled by and/or provide information to other devices, remote servers, operators and/or users. In such context, it is a benefit when the most recent status stored at the server is reliable.

It is an object of the invention to increase the operational performance of communication devices in a network, preferably to increase the reliability of the information in the remote server.

To this end, each one of the second communication devices comprises a memory adapted to store a hopping distance to the first communication device, wherein the second communication device is configured to execute actions based on said hopping distance.

Preferably, the second communication devices are adapted to be operationally connected to a power cutoff detection module, wherein each one of the second communication devices comprises an energy storage module, wherein each second communication device is configured to operate in a power cutoff mode, using energy from the energy storage module, when the power cutoff detection module detects a power cutoff, wherein the second communication device is configured to execute actions based on said hopping distance in said power cutoff mode.

The invention is based on the insight that the primary reason for loosing communication with a communication device is power supply cutoff. In a traditional setting, when the power supply is cut off, communication devices loose their functionality and are unable to communicate. By providing a power cutoff detection module and an energy storage module, communication devices are provided with the possibility to continue their operation at least for some period of time. The power cutoff detection module can operate, depending on the type of input power, based on different working principles. When the device is provided with AC power, cutoff can be detected by detecting missing zero-crossings. When the device is provided with DC power, dedicated circuitry can be provided to detect power cutoff. Further mechanisms to detect power supply cutoff are integrated by reference to WO2019175438. The power cutoff detection module may be provided in the communication device or may be formed inside an external device or may be connected as a dedicated module. When the power cutoff detection module is not part of the communication device, it is configured to send a power cutoff signal to the communication device notifying the latter that power has been cut off.

Two types of devices are provided in a local network. The first type is a device that communicates in the local network and that is also able to communicate with a remote server. To this end, this first device is provided with a short-range communication module and a long-distance communication module. Via the short-range communication module, the mesh or star network is locally created. These mesh or star networks use hopping mechanisms to transmit messages through the network. The long-distance communication module additionally enables the device to communicate with a remote server. A second type of devices comprises a short-range communication module. These devices may have another, for example a long-range communication module which may be disabled. Such type of network is further detailed in WO2016075144, WO2016075102, WO2016075107, WO2016075105, WO2016075116, the content of which being included herewith by reference. Alternatively, these devices only comprise a short-range communication module. Such devices are typically cheaper. These devices communicate in the local network with other devices via the short-range communication module. Messages are transmitted to a remote server first via a hopping mechanism, using the short-range communication modules, from the second communication devices to a first communication device. Secondly, these messages can, upon arrival at the first communication device, be forwarded to a remote server. Messages from the server are transmitted to the second communication devices the other way around, as will be clear to the skilled person. In other words, the messages from the second communication devices are indirectly, particularly via another device of the first type in the local network, transmitted to the remote server.

In the devices of the first type, preferably a first energy storage module is provided to enable these devices to operate in a first power cutoff mode, preferably comprising listen for a predetermined amount of time for messages received from surrounding devices. These messages are typically received from devices of the second type. The devices of the first type transmit these received messages to the remote server. In addition, the devices of the first type may also send their own message regarding their own status.

The devices of the second type comprise a second energy storage module that is configured to enable the device of the second type to operate in a second power cutoff mode, preferably comprising sending a last message in the local network for transmission to the remote server. This set-up has several advantages. A first advantage is that each device is enabled to send a last message to the remote server after power supply cutoff. A further advantage is that local network efficiency is maintained since the devices of the second type, which are the cheaper devices, can be provided with a cheap power supplying module. Part of the invention is further based on the insight that power supply cut off typically affects multiple communication devices located in a small region at the same time. The invention allows all of these devices to execute actions in the power cutoff mode based on their hopping distance from the first communication device. Hopping distance is defined as an integral number of re-transmisions required for a message from a sender to reach a predetermined receiver. This means that if a sender can directly transmit a message to the predetermined receiver, the hopping distance is zero 0. Also, if one intermediate device re-transmits a message from a sender to enable the message to be received by the predetermined receiver, the hopping distance is 1. The invention enables to prevent multiple second communication devices affected by a cutoff to send a last message to the remote server, or to the first communication device, at the same time. The sending of a last message by multiple second communication devices affected by a cutoff at the same time would, in combination with the hopping mechanism provided to transmit these messages to the first communication device, lead to an explosion of the number of messages in the small region of the network. This causes collision of messages and decreases the communication efficiency.

By executing actions in the power cutoff mode based on the hopping distance, it becomes possible to segment the sending of last messages of the second communication devices in the region affected by the power cutoff. In particular, actions may be defined based on the hopping distance such that second devices which are shorter to the first device perform actions differently or perform different actions compared to second devices which are further away from the first device. For example, this enables for second devices which are closer to the first device to listen for a predetermined period of time before sending their own last message to the first communication device. During this listening, these devices may collect messages from other second communication devices for bundled transmission to the first communication device. In this manner, the explosion of number of messages due to a simultaneous loss of power is avoided and messages from multiple second communication devices can be more optimally transmitted to the remote server. This allows the communication devices to update their status at their remote server, such that the information at the server is accurate.

The second communication device may be configured to send the “last” message multiple times, for example, it may be configured to resend the “last” message as long as the first communication device has not sent an acknowledgement message, and as long as the second energy storage module does not run out of energy. Therefore in the context of this description, the term ‘last message’ is defined as one or multiple messages that a device may send after power has been cut off and before the device runs out of backup energy. The last message therefore includes the power cutoff message signaling that power has been cut off, and may additionally include further messages and/or additional information in the message. The first communication device may be configured to send an acknowledgement message to the second communication device upon receipt of the “last” message. Second communication devices may transmit the acknowledgement messages, sent by the first communication device, using the hopping mechanism. The second communication devices may be configured to send their last message several times until it receives acknowledgement from the first communication device and/or from the server.

Using the hopping distance as a parameter to control actions in power cutoff mode has led to further insights that also during normal use, the hopping distance can be used to distinguish or parametrize actions executed by the communication device. For example sensing actions may be periodically conducted wherein the period, frequency or alternating order of sensing actions amongst multiple communication devices in the network is based on the hopping distance. Another example of a use case wherein using the hopping distance might be advantageous relates to switching on of luminaires. When all luminaires in a network are switched on at the same time, a steep increase of the power required by the luminaires is created. This increase can be made less steep by implementing a delay based on the hopping distance.

Preferably, said memory is adapted to store, for different hopping distances, corresponding different parameters for said actions. Alternatively, actions are predefined or programmed in the second communication device with conditions or conditional parameters and the memory merely stores a numeric hopping distance. In each case, based on the data in the memory, actions are executed differently or different actions are executed for second devices with different hopping distances.

Preferably, said actions comprise a sequence of:
receiving a message from a downstream second communication device for transmission to the first communication device; and
transmitting the received message upstream.

Preferably, the step of transmitting is delayed based on said hopping distance. More preferably, the smaller the hopping distance the longer the transmitting is delayed. The delaying of transmitting enables to collect messages from multiple downstream second communication devices and transmitting a bundle of messages upstream. This improves the sequential nature of the transmission of messages and therefore reduces collision of messages in the network. Preferably, different parameters comprise at least a delay time for delaying the step of transmitting.

Preferably, said actions further comprise sending a message indicative for the power cutoff. Further preferably, the sending a message indicative for the power cutoff and the transmitting of the received message is combined.

Preferably, each energy storage module is configured to store a predetermined amount of energy, and the predetermined amount of the first energy storage module may be equal to, or is preferably larger than the predetermined amount of the second energy storage module. Tests have shown that the amount of energy that is necessary for the second communication device to send a last message after power supply cutoff is significantly smaller than the amount of energy needed by the first communication device to transmit messages received and transmit their own last message during a predetermined period after power supply cutoff to the remote server. This has two reasons. A first reason relates to the time necessary to send a single last message, which is smaller than the time necessary to listen for “last” messages and transmits these messages to a remote server. Another reason relates to the power consumption of the long-distance communication module. The long-distance communication module typically consumes significantly more power than the short-range communication module. Therefore, to be able to transmit received messages to the remote server, the amount of energy is significant. Providing all devices in the local network with the same energy storage module would be suboptimal since the second communication devices would be overpowered to send a last message and/or the first communication devices would be insufficiently powered to transmit all received messages to the remote server. A cost effective local network can be built by providing the second devices with a smaller energy storage module than the first communication devices.

In an exemplary embodiment, the first communication device is provided with a switch arranged to allow the powering of a load (e.g. a lamp, a sensor) in a first state and to block the powering of the load in a second state, and the first communication device is configured to put or maintain the switch in the second state after having detected a power supply cutoff, and before the first energy storage module runs out of power. Alternatively, or in addition, the second communication device is provided with a switch arranged to allow the powering of a load (e.g. a lamp, a sensor) in a first state and to block the powering of the load in a second state, and the second communication device is configured to put or maintain the switch in the second state after having detected a power supply cutoff, and before the second energy storage module runs out of power. In that manner, it is avoided that the load is powered automatically when the power supply is restored. More in particular, upon restoration of the power, a controller may set the switch depending on whether or not the load needs to be powered. For example, when the load is a lamp, and when the power is restored during the day, the switch can remain in the second state, whilst if the power is restored during the night, the switch may be put in the first state.

Preferably, the first energy storage module is formed by a battery. Further preferably, the second energy storage module is formed by a capacitor. A capacitor is a less costly component compared to a battery. A capacitor provides a rather small amount of energy during a rather small period of time. This appears to be sufficient for the second communication device to send a last message after power supply cutoff. The first communication device is provided with a battery typically providing significantly more energy than a capacitor. Furthermore, a battery typically provides energy over a significantly longer period of time than a capacitor. Therefore the first communication device is enabled via the battery to continue its operation and to listen for messages received from other devices in the local network and to transmit these messages to the remote server.

Preferably, the devices are luminaire devices and the local network is an outdoor lighting network. By outdoor luminaires, it is meant luminaires which are installed on roads, tunnels, industrial plants, stadiums, airports, harbors, rail stations, campuses, parks, cycle paths, pedestrian paths or in pedestrian zones, for example, and which can be used notably for the lighting of an outdoor area, such as roads and residential areas in the public domain, private parking areas and access roads to private building infrastructures, etc. In outdoor lighting networks, two root causes are relevant for particular embodiments of the present invention.

A first root cause relates to a mechanism to turn off the lights. In many outdoor lighting situation, when the lights are to be turned off, the power is cut. However, the communication devices receive power via the power supply of the luminaire Therefore, cutting off the power supply of the luminaire would also cut off the power supply to the communication device. In a traditional situation the lights would go out, which is the desired result, but the communication devices loose power and therefore loose the ability to communicate with the remote server. At the remote server, the status of the luminaire cannot be updated and the operator cannot verify via the remote server that the lights are out. Additionally, at the remote server, the most recent status of the luminaire, at the moment before the power cutoff, cannot be updated.

A second root cause relates to power cable theft, cable break, lightning strike, tripped master circuit breaker or other cable or driver or other internal malfunctioning. Internal malfunctioning might lead to an undesirable disconnection of the controller from the luminaire. Yet another situation may occur wherein the connector of the controller is unplugged from the luminaire socket. With a battery system inside the controller, the controller is able to send a message to the server to indicate this unplug action. The unplug action may be desired, for example for maintenance reasons, or undesired, for example in case of theft or vandalism. When a power cable is compromised, the power gets cut off. Such power cutoff typically occurs in a small area. This area is directly related to the physical construction of the network, particularly to the structure of the cable network. In a traditional situation, the lights will go out, the communication devices powered via the power supply of the luminaire lose the ability to communicate in the local network, and the operator is not notified that the luminaires go out and that there is a malfunctioning. In local networks where luminaires are permanently powered, also during the day, power cutoff may occur during daytime when the luminaires are switched off. Such power cutoff would in a traditional setup only be recognized when the lights should go on and fail. With embodiments of the present invention, the power cutoff is detectable during the day and appropriate action can be taken.

Embodiments of the local network allow the network devices to send a last message after power cutoff such that the status of the luminaires is updated in the remote server. When the lights are turned off, the remote server will show to the operator that the lights are turned off. When e.g. a cable breaks, the operator can see via the remote server that a limited number of luminaires are turned off. In a cable breaking situation, the turning off is not related to a power cut initiated or expected by the operator such that a malfunctioning can be detected. This should be a sign to the operator that there is a problem. When the operator has knowledge of the physical structure of the network, the operator can detect the origin of the problem and can take specific action.

Preferably, each luminaire device comprises a housing enclosing a lamp and a driver for said lamp, and each luminaire device comprises a controller for controlling the device, wherein the controller comprises the communication module. The communication modules are preferably configured to receive instructions via the local network, and to control the lamp via the driver based on the instructions. Luminaire networks in general are known and the advantages are also known.

In a preferred embodiment, the housing is configured to provide an IP protection class of IP66, IP67 or IP68 in accordance with DIN EN 60529. Typically, the housing corresponds with the housing of the luminaire head. This housing may then be fixed to a support pole.

Optionally, the controller is arranged outside the housing and connected to the driver via a socket. Further preferably, the controller comprises the energy storage module. Providing the energy storage module in the controller requires no modifications to the luminaire. The controller can be connected to the luminaire via the socket in a traditional manner Controllers can be replaced, in particular, a prior art controller can be replaced by a controller according to an embodiment of the present invention to update and improve the local network. The socket may be a NEMA socket (notably as disclosed in the ANSI C136.10-2017 standard or the ANSI C136.41-2013 standard) or a Zhaga socket, or any other known type of socket.

In another embodiment, the controller may be arranged inside the housing. The energy storage module may be included in the controller or in the driver or in a separate element.

Also the controller may be arranged integrated with the driver. The driver may be arranged inside or outside of the housing.

In yet another embodiment, the controller may be arranged as a modular element to be integrated or pluggable in the housing of a driver or in the housing of the luminaire. Also, the energy storage module can be in the driver and optionally can be a pluggable module to be inserted in the housing of the driver. In both cases, the driver can be inside or outside the luminaire housing.

Preferably, the energy storage module is arranged inside the housing and connected, for example via the socket, to the controller. According to this embodiment, the controller can be made compact, since it does not comprise the energy storage module. An end customer can choose to integrate an energy storage module in the housing of the luminaire to enable the communication devices to send a last message after power cutoff. When an end customer does not need this functionality for one or more luminaires, he could choose not to integrate an energy storage module in these luminaires, thereby saving costs. A further advantage of arranging the energy storage module inside the housing relates to maintenance. The controller is typically formed with a rigid watertight casing, in particular when arranged outside the luminaire housing. In this case, the controller is generally not provided to be opened. The housing of the luminaire, however, can be opened to replace the driver, the lamp, sensors, etc. By providing the energy storage module inside the housing of the luminaire, the energy storage module can be replaced. This appears to be an advantage since the maximum lifetime of a battery is less than the maximum lifetime of a controller.

Preferably, the short-range communication module is an IEEE802.15.4 module, for example a zigbee module or a wi-sun module. Further preferably, the long-distance communication module is a cellular module. Further preferably, the local network is a mesh or star network. Zigbee networks are preferred local network for luminaire networks. A zigbee communication module is considered a short-range communication module. The zigbee protocol allows to build mesh or star topology networks. A cellular module is a long-distance communication module that enables a device to communicate with a remote server. When one or multiple devices in the local network are provided with cellular modules, the devices in the local network communicate to the remote server via this cellular module.

Preferably, the set further comprises the remote server, and the remote server is adapted to track the status of each of the communication devices in the local network. The advantages are described above and allow an operator to see a correct status of the devices, such as luminaire devices, also for the devices that are cut off from their power supply. An example of a luminaire device is given hereunder. The skilled person will understand that this is merely an example, and other devices such as sensors, actuators and other devices may be served by a similar communication device.

According to an embodiment, the message(s) sent by the first communication module may be used for indicating other information than a power cutoff, such as a setting at cutoff, e.g. a dimming level, an energy consumption level of the first and/or second communication module at cutoff, last measured sensor data, etc. This allows to provide information about what each luminaire was doing just before the cut off. In other words, the device does not just send a message to indicate that the luminaire detects a power cut off, but also informs the server on the status of the luminaire just before the power cut off. Also, the message sent by the second communication module may be used for indicating other information than a power cutoff, such as a setting, a dimming level, an energy consumption level of the second communication module at cutoff, last measured sensor data, etc. Also, a message may contain any one or more of the following: identification data of the first and/or second communication devices, the available quantity of energy from the first and/or second energy storage module, a time period during which the first/second communication device will still be supplied with power.

Further, one or more actions may be performed upon detection of the power cutoff, depending on the available energy in the first/second energy storage module. In an exemplary embodiment, priority rules may be applied to the one or more actions to be performed after power cutoff. For example, the one or more actions to be performed may be further determined as a function of the quantity of energy still available in the energy storage module. A possible action may be the storing of recently received data, the sending of relevant data, and where the communication device serves a functional unit such as a video camera, it may be desirable to move certain parts of the functional unit into a shut-off position, e.g. to close a protection of the video camera or to set the functional unit in a stand-by mode.

The invention further relates to a method for operating a communication device in a local network via a hopping mechanism using a short-range communication module, the method comprising:
storing a hopping distance to a predetermined other communication device in the local network;
detecting a power cutoff via a power cutoff detection module;
operate the communication device in a power cutoff mode, using energy from an energy storage module, wherein actions are executed based on the stored hopping distance.

The skilled person will understand that the hereinabove described technical considerations and advantages for the set of devices adapted to form a local network, also apply to the method for operating a communication device, mutatis mutandis.

After power supply cutoff, the energy available to the communication device is limited, particularly to the energy available in the energy storage module. After cutoff, the communication device is operated in a power cutoff mode. In power cutoff mode, engineering and design choices are primarily made to optimize energy usage. In power cutoff mode, a predetermined number of actions is performed by the communication device optionally in cooperation and/or communication with a device served by the communication device such as a luminaire, sensor, . . . . These predetermined actions are statically or dynamically determined. When these actions are statically determined, the communication device is pre-programmed to perform a predetermined number of actions after power cutoff. When these actions are dynamically determined, the communication device adapts the number of actions based on a number of parameters. In any case, these actions are based on the hopping distance.

The decisions regarding actions to perform based on the hopping distance can be made by the communication device itself and/or can be made by a server which sends configuration message to the communication device to configure the latter accordingly. The predetermined actions may comprise actions to be performed by the communication device and/or actions to be performed by the external device and/or actions to be performed by a combined operation of the communication device and the external device. Where the communication device serves a functional unit such as a video camera, the predetermined actions may comprise actions to be performed by the functional unit. An example of an action to be performed by the external device is switching the external device into standby mode. To enable dynamic determination of the actions based on the hopping distance, preferably the communication device and/or server comprises a list of actions and a corresponding hopping distance.

The communication device and/or server may decide, based on the hopping distance, which actions to execute in power cutoff mode. Preferably, the decisions regarding actions to perform are made by a server which not only monitors each communication device as an individual device, but also considers neighboring communication device to determine an action strategy that is beneficial for a whole group of communication devices. This allows for example to change a communication path in power cutoff mode to optimize and balance the energy usage of the different communication devices depending on the statuses of the different energy storage modules.

Decisions regarding actions to perform may be further based on an amount of energy in the energy storage module. After receipt of the signal of the power cutoff detection module, the processor operates the communication device in power cutoff mode. The capability of the energy storage module to store a given amount of energy changes over time. Temperature can influence this amount of energy. Age, due to decay over time, significantly influences the amount of energy that can be stored in the energy storage module. It may be preferable to determine and/or monitor the amount of energy in the energy storage module, and to store a value indicative of this amount in the memory. This information can be retrieved from the memory and forms the basis for optimization of the one or more predetermined actions. In other words, by storing in the memory the value indicative of the amount of energy, an operator is enabled to optimize the use of the energy after cutoff from the power grid. According to examples of the invention, this optimization could include performing a sensor measurement, and/or transmitting one or more last communication messages thereby increasing the reliability of the information in the remote server. The operator is also enabled to detect an insufficiency or optionally predict a future insufficiency of the amount of energy to send a last message. Sending a last message after cutoff from the power grid updates the status of the communication device at the remote management server. Detecting or predicting such insufficiency allows efficient maintenance and/or replacement, thereby increasing the reliability of the information in the remote management server. This optimization could further include changing communication paths in the network.

Preferably, the determining of the amount of energy includes at least measuring the energy remaining in the energy storage module after the predetermined number of actions have been performed. Preferably, the value stored in the memory relates to the energy remaining By measuring the energy remaining in the energy storage module after the number of actions have been performed, the energy surplus is determined. This energy surplus will decrease over time, so that the operator can detect when preventive maintenance is required. Alternatively the processor can adapt the predetermined actions accordingly. Also, the energy surplus can be used to perform extra actions which are deemed unnecessary but useful.

Preferably, the communication device comprises a clock and the processor is adapted to determine the amount by counting, via the clock, an operational time of the processor in power cutoff mode. Preferably, the processor is adapted, in power cutoff mode, to periodically store in the memory a value indicative of the time passed. When the processor runs on energy from the energy storage module, the processor will at an unknown moment in time stop working. By periodically storing a value in the memory, upon rebooting the processor, the value stored last before the processor stopped working will provide an indication of the running time of the processor. This running time is proportional to the amount of energy in the energy storage module. Preferably, the processor is adapted, in power cutoff mode, to periodically overwrite said value with a higher value.

Preferably, a further value is stored in the memory indicating the time passed between cutoff from the power grid and finishing performing the predetermined number of actions, the combination of the further value and said value being an indication of the total time of operation of the processor in power cutoff mode. Advantages and effects are described above in relation to the set of devices adapted to form a local network. By operating the communication devices in a power cutoff mode based on the hopping distance, consumption of these devices can be restricted. This maximizes the time period after power cutoff that the communication device stay functional for sending last messages to the remote server. In power cutoff mode, predetermined functionalities or tasks of the communication devices can be stopped, for example sending control signals to the driver of the luminaire, because they are irrelevant in a power cutoff situation.

Preferably, the first and/or second energy storage module are charged using the power supply. When power supply is cut off, the energy in the energy storage module is used to enable the communication device to send a last message to the remote server. When power supply is restored, the energy storage modules are preferably charged via the power supply, such that the energy storage modules can once again deliver power to the communication devices to send a last message after a subsequent power supply cutoff. Alternatively or in addition, the energy storage module could be charged using solar energy or energy harvesting from heat dissipation and/or vibration.

The skilled person will understand that the hereinabove described technical considerations and advantages for the set of devices adapted to form a local network, also apply to the below communication device, mutatis mutandis

Preferably, the operating comprises:
receiving a message from a downstream second communication device for transmission to the first communication device; and
transmitting the received message upstream.

In a hopping mechanism, messages are transmitted from downstream to upstream and vice versa. In the specific situation of a power cutoff where the objective is to update the information in the remote server, particularly the upstream transmission of messages is of particular relevance. To control the messages sent by multiple devices affected by a power cutoff, it is advantageous to define actions in a power cutoff mode being receiving a message and transmitting the message. In a hopping mechanism, the receiving of a message typically forms the trigger to transmit the message to a next communication device in the hopping path. By defining an operating action specifically to the receiving of one or multiple messages, the transmitting may be uncoupled from the receiving allowing to optimize the use of energy and to avoid collision of messages. Preferably, the step of transmitting is delayed based on said hopping distance. As a result of the delay of the transmission, multiple messages may be received at the communication device before the latter starts transmitting these messages. Preferably, the step of transmitting further comprises grouping one or multiple received messages into a single message to be transmitted upstream.

The invention further relates to a communication device comprising a short-range communication module to communicate in the local network via a hopping mechanism, the communication device further comprising a power cutoff detection module, an energy storage module and a memory, wherein the memory is adapted to store a hopping distance to a predetermined communication device in the network, wherein the communication device is configured to operate in a power cutoff mode using energy in the energy storage module when the power cutoff detection module detects a power cutoff, wherein the power cutoff mode executes actions based on said hopping distance.

The invention will now be described in more details with respect to the drawings illustrating some preferred embodiments of the invention. In the drawings:

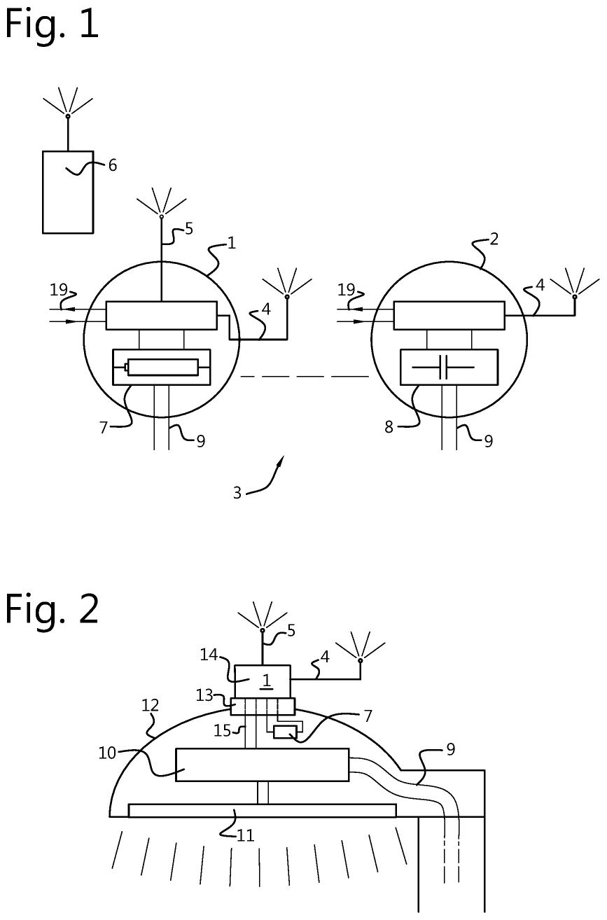

FIG. 1 illustrates a local network according to an embodiment of the invention;

FIG. 2 illustrates a luminaire according to a first embodiment of the invention;

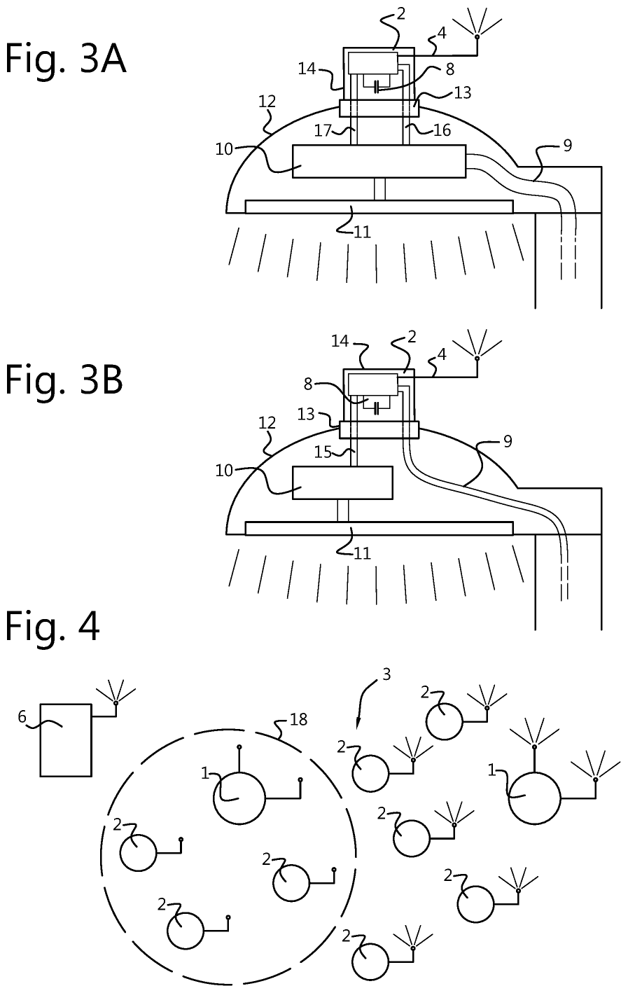

FIGS. 3a and 3b illustrate a luminaire according to a second embodiment of the invention;

FIG. 4 schematically illustrates a local network according to an embodiment of the invention;

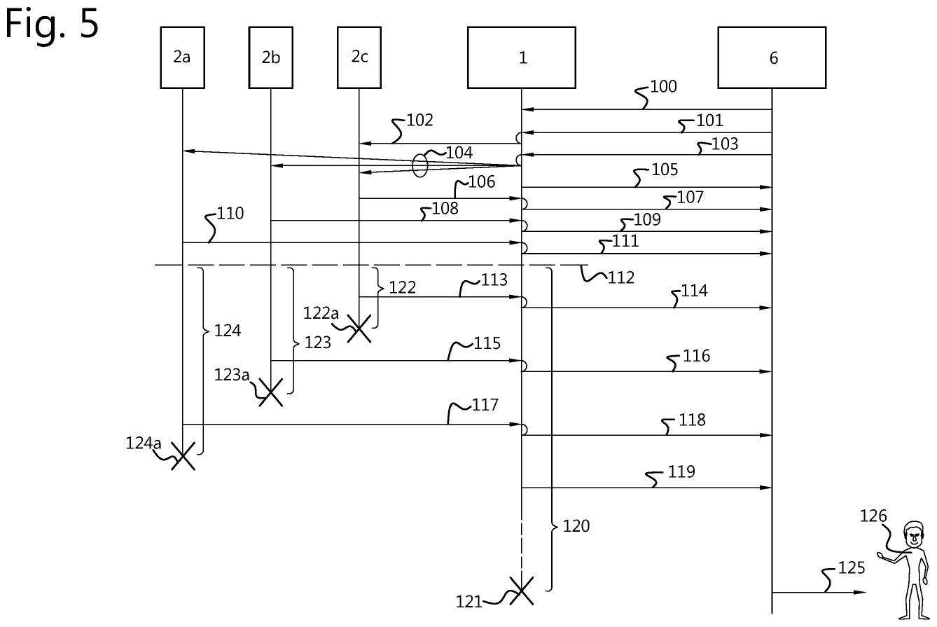

FIG. 5 illustrates how messages are transmitted in the local network according to an embodiment of the invention; and

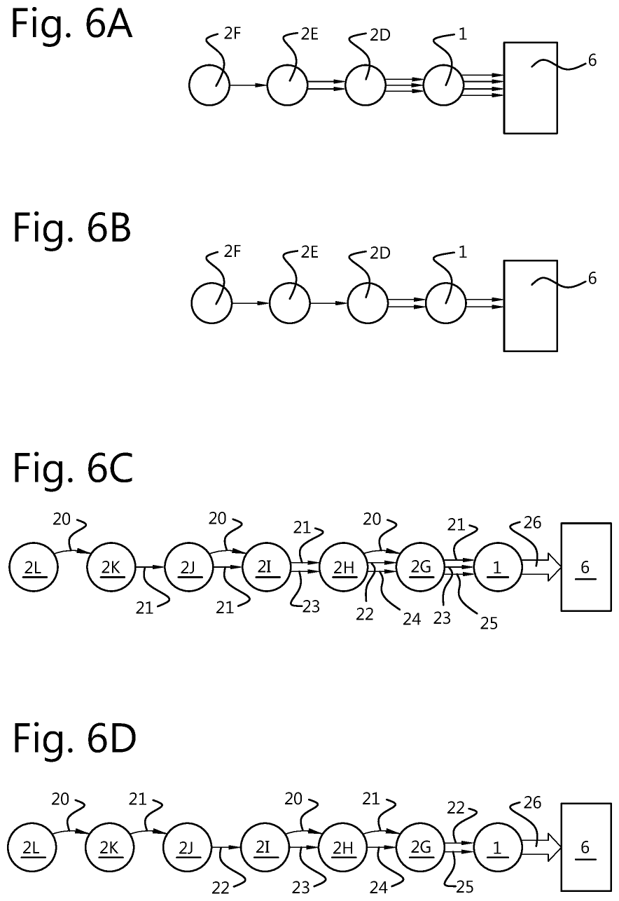

FIGS. 6a-6d illustrate several possible scenarios of communication in the network, based on the hopping distance, in case of power cutoff.

In the drawings a same reference number has been allocated to a same or analogous element.

The invention particularly relates to the operation of the devices in a local network. First, the local networks and devices used therein will be described in some embodiments with reference to FIGS. 1-4. Secondly, a more general explanation is given in relation to operation of a device in power cutoff mode, including the transmission of a last message. Thirdly, as of FIG. 6, more specific examples of the invention are described including examples showing how the actions can be defined differently based on the hopping distance of a device in the network.

FIG. 1 shows a first embodiment of the present invention. FIG. 1 shows a first communication device 1 and a second communication device 2. The devices form a local network 3. The first communication device 1 is a device of a first type. The terms ‘first communication device 1’ and ‘device of the first type 1’ are both used in this description to refer to the same device. This device of the first type 1 is characterized by having two communication modules, a short-distance communication module 4 and a long-distance communication module 5. The short-distance communication module 4 is adapted to enable communication between multiple devices in the local network 3 over a predetermined maximum distance. Via the short-distance communication modules 4, the local network 3 is formed. Depending on the type of short-distance communication module 4, the distance is limited to a guaranteed maximum of 2.000 m, preferably a guaranteed maximum of 1.000 m, more preferably a guaranteed maximum of 500 m, most preferably a guaranteed maximum of 100 m. The short-distance communication module is further preferably a low power module. Examples of such short-distance communication modules 4 include ZigBee, WiFi, thread, Bluetooth, wi-sun.

The long-distance communication module 5 is adapted to enable communication with a remote server 6. In other words, the long-distance communication module 5 enables communication outside the local network 3, preferably with another network such as the internet, most preferably. Depending on the type of long-distance communication module, the distance is minimum 5 km, preferably minimum 10 km, more preferably 20 km Examples of such long-distance communication module include LoRa, cellular (GPRS, 3G/4G/5G), and power line communication networks, which normally have limited bandwidth.

The second communication device 2 is a device of a second type. The terms ‘second communication device 2’ and ‘device of the second type 2’ are both used in this description to refer to the same device. The device of the second type 2 is characterized by having a short-distance communication module 4. In other words, the device of the second type 2 does not have a long-distance communication module 5. Therefore, this second communication device is unable to directly communicate with a remote server 6. However, when installed in a local network 3, the second communication device 2 can indirectly communicate with the remote server 6 via the first communication device 1. This is further explained hereunder.

Building a local network 3 with a combination of devices of the first type 1 and devices of the second type 2 has multiple advantages. A first advantage is related to costs. It will be clear to the skilled person that a second communication device 2 is cheaper due to the absence of the long-distance communication module 5 than the first communication device 1. In an alternative embodiment, the hardware of all communication devices is identical or at least substantially the same, to reduce costs in mass production. In such communication devices, the long-distance communication module 5 is disabled or deactivated for the second communication devices 2. Therefore, overall costs can be reduced by using multiple devices of the second type 2 in a local network 3. A local network 3 should comprise at least one device of the first type 1 so that the multiple devices in the local network can communicate to a remote server 6 via this first communication device 1. These multiple devices of the second type communicate via a hopping mechanism.

A hopping mechanism enables multiple devices to transmit data over long distances by passing data through a network of intermediate devices to reach a more distant one. In other words, the first communication device can be reached in the network by passing data through multiple second devices in the network. Such passing data through is known as hopping. A data package is hopped, which is another word for transmitted, from one communication device to a next communication device such that a communication path is virtually created between a sender device and a receiver device. Sender device and receiver device could be any predetermined device in the local network. In the context of the invention, each second device in the local network 3 is connected to the remote server 6, via a first communication device 1 and via a hopping mechanism within the local network 3. The communication path in the local network 3 may be predetermined or may be dynamically determined. Based on the communication path, the number of hops between each of the second communication devices 2 and the first communication device 1 may be determined. This number of hops is fixed at least when the communication path is predetermined. This number of hops is alternatively varying around an average number when the communication path is dynamically determined. In any case, a hopping distance may be determined based on the fixed or average number of hops. The hopping distance is a measure or an indication of the operational distance between a second communication device 2 and a corresponding first communication device 1 in the local network.

The local network 3 preferably extends over a predetermined limited area to connect multiple devices in that area. The first and second communication device 1, 2 each comprise at least one of an input and/or output, illustrated with reference number 19. Via the input and/or output, external devices can receive and/or send data from/to the communication device 1, 2. The skilled person will understand that such local network 3 enables such external devices to communicate with each other and/or to communicate with a remote server 6 via the communication devices 1, 2. The local network 3 is typically provided with a mesh or star or tree topology. When the local network has a star topology, the central communication device is preferably of the first type 1.

Each of the first and second communication device 1, 2 is provided with a power supply 9. Via the power supply 9, the communication device 1, 2 receives the power or energy that is needed to operate the communication device. The electronic circuits in the communication device 1, 2, the short-distance communication module 4 in the devices and, when present/activated, the long-distance communication module 5 is powered via the power supply 9. The power supply 9 is typically connected to the external power supply of the external device that communicates to the input-output 19.

In the embodiment of FIG. 1, the first communication device 1 comprises a battery 7. The battery is charged when the power supply 9 is connected. When the power supply 9 is disconnected, or the power is cut, which can have multiple reasons or causes, the battery provides energy to the communication modules 4, 5. The battery 7 is dimensioned such that the first communication device 1 can continue its operation during a predetermined period of time after power cutoff is detected. A power cutoff detection module (not shown) is provided, which can be formed as separate circuitry or which can be integrated in the power convertor of the communication device 1. The power cutoff detection module can be arranged as part of the communication device 1 or may be arranged as an external module or may be part of the driver. In the predetermined period of time after power cutoff, the first communication device listens for messages received via the short-distance communication module 4. When the first communication device 1 receives a message, it transmits the message via the long-distance communication module 5 to the remote server 6. It will be clear that the first communication device 1 also sends a message to the server regarding its own status, i.e. when it detects a power cutoff, in the same manner as the second communication device 2.

The battery is preferably dimensioned such that the predetermined period of time is at least 10 seconds, preferably at least 30 seconds, more preferably at least 60 seconds, most preferably at least 300 seconds. The reason for configuring the first communication device 1 as described above is based on the insight that when power goes down, this typically affects more than one external device and corresponding communication device 1, 2 in the local network 3. Therefore communication device of the second type 2 are sending their last messages to the first communication device 1 for transmission to the remote server 6. By configuring the first communication device such that it can continue its operation for a predetermined period of time, messages from surrounding communication devices of the second type can be captured and transmitted to the remote server. The operating mode of the first device is preferably switched, upon detection of power supply cutoff, from normal operational mode into power cutoff mode. Power cutoff mode is configured to reduce power consumption of the communication device compared to normal operational mode.

The second communication device 2 comprises a capacitor 8. When power is provided via the power supply 9 to the second communication device 2, the capacitor 8 is charged. When the power supply 9 is disconnected or the power is cut off, the capacitor 8 provides the second communication device 2 with sufficient power to send at least one message. The operating mode of the second device is preferably switched, upon detection of power supply cutoff, from normal operational mode into power cutoff mode. Power cutoff mode is configured to reduce power consumption of the communication device compared to normal operational mode. In an exemplary embodiment, the message sent by the second communication device 2 after detection of the power cutoff is as short as possible, for example the message can be sent in a single telegram, and requires a minimum of computing power. This increases the reliability of the operation of the second communication device 2 after power cutoff. After power cutoff, potential queuing of messages is ignored and the ‘last message’ is sent immediately.

In the local network 3, hopping is used to transmit messages from a communication device of the second type 2 to a communication device of the first type 1 for transmission to the server 6. In some situations, two or more hops are needed for a message to reach the communication device of the first type 1. In such local networks, the energy storage module 8 in the second communication devices 2 are dimensioned not only to send a last message by the second communication device 2, but also to continue the message transmission functionality for at least a predetermined period of time. Still, the amount of energy stored in the second energy storage module 8 will be significantly smaller than the amount of energy stored in the first energy storage module 7 because the short-distance communication modules 4 consume significantly less energy than the long-distance communication module 5. Therefore, even when the predetermined period of time for continuous operation of the first communication module 1 and the second communication module 2 is identical, still the predetermined amount of energy of the second energy storage module would be significantly smaller than the predetermined amount of energy of the first energy storage module.

In the embodiment of FIG. 1, the first energy storage module 7 is illustrated as a battery and the second energy storage module 8 is illustrated as a capacitor. The skilled person will understand that these are mere examples and that the type of energy storage module can be selected based on the above described functional requirements by the skilled person. Alternatively, the energy storage modules may be identical or at least substantially the same for the first and second communication devices. The energy storage modules can be selected from batteries, capacitors, series of capacitors, thermo-electric generators, solar panels, and other modules capable of storing and/or generating a limited amount of energy.

FIG. 2 shows a luminaire device comprising a housing 12. The housing encloses at least one lamp 11 and a corresponding driver 10. Alternatively the driver is outside the luminaire housing, e.g. in the pole. The driver 10 controls the output of the lamp 11. In some embodiments, multiple lamps are provided to be controlled by one or multiple drivers. Sensors can also be added to the luminaire, for example motion sensors, humidity sensors, environmental sensors including pollutant sensors, light sensors, temperature sensors, visibility sensors etc. The sensors can be arranged inside and/or outside the housing 12. An external power supply 9 is typically provided to power the multiple components in the luminaire. In the embodiment of FIG. 2, the external power supply 9 is connected to the driver 10, and the driver 10 distributes the power among the components in the luminaire. Optionally, the driver 10 is physically and/or functionally segmented such that several drivers may be present.

The housing 12 of the luminaire is provided with a socket 13. This socket can be formed as by any known type of socket. Such socket may provide a mechanism to provide the controller with a 24V DC signal, as shown in FIG. 3a which shows a Zhaga socket. Alternatively, the socket may be connected to the main power supply and be provided to distribute the power to other devices, as shown in FIG. 3b. Such socket may be formed as a socket fulfilling the requirements of the ANSI C136.41-2013 standard or the ANSI C136.10-2017 standard. Such socket is provided to receive the 230V AC power signal, and to provide power to the driver of the luminaire.

A controller 14 is connected to the luminaire, preferably to the socket 13. The controller 14 preferably comprises a communication device 1, 2. In the embodiment of FIG. 2 the controller 14 comprises a first communication device 1 having both a short-distance and a long-distance communication module 4, 5.

The first energy storage module 7 is provided inside the housing 12 of the luminaire. As described above, this facilitates maintenance. When the first energy storage module 7 is formed as a battery, it could be necessary to replace the battery periodically, for example once every five years. This is particularly beneficial when the lifetime of the controller 14 is expected to be higher than the lifetime of the energy storage module. In the embodiment of FIG. 2, a connection 15 is illustrated between the driver 10 and the controller 14. Via this connection 15, power is transmitted and communication messages are exchanged between the driver 10 and the controller 14. Via an additional connection, the energy storage module 7 is connected to the controller 14.

The power cutoff detection module (not shown) may be provided in the controller 14, or may be arranged in the housing 12 of the luminaire as a dedicated module. Further alternative, the power cutoff detection module may be arranged in the driver 10 or in the socket 13. Preferably the power cutoff detection module is provided as part of the controller 14. This makes the controller 14 independent from the device it is connected to. It may be connected to any driver or any external device.

The skilled person will understand that the embodiment of FIG. 2 is a mere example, and that multiple modifications can be made without affecting the overall operation of the luminaire. For example, the connection 15 could be split in a power connection and a data connection so that the socket 13 would have three pairs of connectors. The transmission of energy and/or signals through the socket 13 can be formed physically, being a wired connection, or optical or electromagnetic, for example via coils. Instead of setting up a direct communication between the driver 10 and the controller 14 electronics can be provided in the housing 12 of the luminaire as an intermediate element, to which for example also one or more of the described sensors can be connected.

In luminaire networks, there has been a history of switching off the lights by simply switching off the main power 9. Recent developments have added additional functionalities and possibilities to control the luminaires Even with advanced control mechanisms it remains common practice to switch off the lights in the morning by switching off the power 9. Because the energy storage module 7 is provided in the luminaire 12 to provide energy to the communication device 1 in the controller 14, the communication device is able to update its status in the remote server 6 before being switched off. The controller 14 preferably comprises a mechanism to measure the external power 9 such that it can detect a cutoff of the external power supply 9. Upon detection of the power cutoff, the controller 14 is configured to send a status update to the remote server via the first communication device 1. This allows the remote server to show the most recent events, also when this most recent event is a power cutoff. This makes the information in the remote server more reliable.

FIG. 3a shows an alternative embodiment of a luminaire. The luminaire comprises a housing 12 enclosing a lamp 11 and a corresponding driver 10. The luminaire also comprises a socket 13 for mounting a controller 14. In the embodiment of FIG. 3a, the controller 14 is provided with a second communication device 2. In the embodiment of FIG. 3a, the energy storage module 8 is provided inside the controller 14. Therefore, in this embodiment, the energy storage module 8 is located outside the housing 12 of the luminaire. In this embodiment the energy storage module 8 can only be replaced together with the controller 14. This is a beneficial situation when the lifetime of the energy storage module is expected to be about the same as the lifetime of the controller 14. In the embodiment of FIG. 3a, a communication connection 16 is provided between the controller 14 and the driver 10, and a power connection 17 is provided between the controller 14 and the driver 10. The operation and advantages of the embodiment of FIG. 3a are analogue to the operation and advantages described in relation to FIG. 1 and FIG. 2. The skilled person will understand, on the basis of the description above, how the luminaire 12 can send a status update after power cutoff. In FIG. 3a, the controller typically receives a 24V DC signal from the driver. Control circuitry is provided in the controller 14 to detect power supply cutoff.

FIG. 3b is comparable to FIG. 3a, but in the embodiment of FIG. 3b the main power supply is connected to the controller 14, via the socket 13. The power supply cutoff module in FIG. 3b can be formed by zero-crossing detectors. When a predetermined number of zero-crossings is missing, power supply cutoff is detected. In FIG. 3b, connection 15 is illustrated between the driver 10 and the controller 14. Via this connection 15, power is transmitted from the controller 14 to the driver 10 and communication messages are exchanged between the driver 10 and the controller 14.

FIG. 4 shows a schematic illustration of a local network 3 built with a combination of communication devices of the first type 1 and communication devices of the second type 2. The ratio of the number of communication devices of the second type 2 to the number of communication device of the first type 1 is preferably at least 2:1, more preferably at least 3:1, more preferably at least 5:1 and can go up to 10:1, 20:1, 50:1, 100:1 and more. The devices of the second type 2 can communicate to the server 6 via the communication devices of the first type 1.

In FIG. 4 a zone 18 is marked, which is a part of the local network 3. When the power goes down in this zone 18, communication devices 1 and 2 within this zone 18 can send a status update to the remote server 6, using the above described mechanism. Particularly, in the context of outdoor lighting networks, this is a significant advantage. A local loss of power can have multiple reasons, for example cable theft, cable break, lightning strike, tripped master circuit breaker or other cable malfunctioning. Independent from the reason, it is a benefit that the loss of power is communicated to the remote server 6. The remote server 6 is preferably programmed to generate a warning signal when unexpected loss of power messages are received. The skilled person will understand that when power is switched off in the morning, and loss of power messages are received from all or nearly all devices in the local network 3, these messages do not qualify as unexpected loss of power messages. However, when during the night, a segment of the local network 3 looses power, the correspondingly received messages can be considered as unexpected. These unexpected messages can trigger an alarm to an operator, which operator can decide whether and how to take action. This allows an operator to restore the power supply as soon as possible, thereby increasing the operation and safety of the luminaire network.

Mechanisms can be provided to detect the origin of the power failure by mapping the loss of power messages onto a power grid map. In most situations this reduces the physical area wherein the problem causing the power cutoff can be reasonably expected. This reduces local network maintenance costs and decreases the time needed to detect the problem. The last message may contain other information than just power cutoff information. This other information might provide an operator with an indication on the reason of the power cutoff.

FIG. 5 illustrates how messages are transmitted in the local network. FIG. 5 shows one first communication device 1 and three second communication devices 2a, 2b, 2c. FIG. 5 furthermore shows the remote server 6. The upper part of FIG. 5 shows normal operation of the local network. In normal operation, the server can send messages, for example instruction messages, to the communication devices. Different examples of such messages are illustrated by arrows 100-104. Arrow 100 illustrates an instruction message from the server 6 to the first communication device 1. Message 102 is an instruction message for a second communication device 2a. Since the server cannot directly reach the second communication device 2a it sends the message to the first communication device, see arrow 101, which transmits the message to the second communication device 2a, see arrow 102. In another embodiment, the server 6 can send more general messages, which are received by the first communication device, see arrow 103, and which is further distributed in the local network to all second communication devices 2a, 2b, 2c, see arrow 104.

In normal operation mode, communication devices 1 and 2 are typically provided with a mechanism to send messages to the remote server 6. These messages typically comprises status update information. These messages are shown in FIG. 5 by arrows 105-111. Arrow 105 illustrates a message from the first communication device 1 to the remote server 6. Arrows 106, 108 and 110 illustrate messages from the second communication device 2a, 2b, 2c, respectively, to the remote server 6. However, since the second communication devices 2a, 2b, 2c cannot directly reach the remote server 6, these messages 106, 108, 110 are transmitted to the first communication device 1, that transmits messages to the remote server 6 as is illustrated by arrows 107, 109 and 111.

The skilled person will understand that mechanisms can be provided to optimize the flow of data and messages through the local network, for example by combining multiple messages from second communication devices into a single message to the remote server. The skilled person will also understand that not all devices 1 and 2 in the local network must be able to bi-directionally communicate. Some devices might only be provided to receive instructions, other devices might only be provided to send data. The invention is applicable in such cases.

In FIG. 5, dotted line 112 illustrates a power cutoff. Without energy storage modules, the communication devices 1 and 2 would not be able to communicate after the power cutoff 112. However, since these devices are provided with energy storage modules, as is explained above, communication devices 1 and 2 are able to notify the power cutoff to the remote server 6. To this end, each of the second communication devices 2a, 2b, 2c send a last message via the first communication device 1 to the server 6. The first communication device 1 receives the messages 113, 115, 117 from the second communication devices 2a, 2b, 2c and transmits these messages to the server 6 as is illustrated by arrows 114, 116, 118. Typically, the first communication device 1 also sends a power cutoff message 119, or a last message 119 to the server 6 to update its status. The first communication device 1 is provided to operate for a predetermined time 120 after power cutoff 112. The second communication devices 2a, 2b, 2c typically stop working a short time after sending their last message. This is illustrated by sign 122 and 122a, 123 and 123a, 124 and 124a, respectively showing the time period wherein the device continues operation after power cutoff 112 and the point in time where it stops.

The first communication device 1 continues its operation typically for a longer period, and stops working as is illustrated in FIG. 5 with sign 121. The skilled person will understand that the messages shown in FIG. 5 could in practice be sent in a different succession. The last messages 113, 115, 117 and 119 typically comprise a status update for the remote server 6. This status update comprises at least information indicating that the power is down. Further, preferably, the last message comprises the latest measured sensor information and/or latest device status information. By receiving these messages at the server 6, an operator 126 checking the status of the luminaires via the server, illustrated by arrow 125, will see the most recent status of the devices, even after power cutoff. Therefore, the information provided by the server 6 to the operator 126 is reliable.

The operation of the second communication devices is based on the hopping distance, which is described above. FIG. 6a illustrates a drawback when all communication devices operate in the same way in the network, thus not based on the hopping distance. FIG. 6a illustrates a communication path between a second communication device 2F and the remote server 6. The second communication device 2F communicates to the server 6 via the first communication device 1 and further via the second communication device 2D and the second communication device 2E. The hopping distance between the second communication device 2F and the first communication device 1 is two, namely a data package is transmitted two times being by the device 2E and the device 2D before it reaches the first communication device 1. In an analogue way, FIG. 6a illustrates the communication path between the second communication device 2E and the first communication device 1. The hopping distance for device 2E is 1. In an analogue way, FIG. 6a illustrates the communication path between the second communication device 2D and the first communication device 1. The hopping distance for device 2E to the first communication device 1 is 0 because there is a direct communication between the device 2E and the first communication device 1. The first communication device 1 re-transmits all messages to the server 6. The first communication device 1 may group multiple message for re-transmission to the server 6, or may re-transmit the messages individually.

FIG. 6a illustrates the communication messages that can reasonably be expected between second communication device 2F and the remote server 6 in case of a power cutoff when actions of the devices are not based on a hopping distance. Second communication device 2F will transmit a ‘last message’. To distinguish between ‘last messages’ of different devices, this last message will be ‘last message 2F’. Second communication device 2E also transmits a ‘last message’ being ‘last message 2E’. However, second communication device 2E also receives ‘last message 2F’ for transmission. Therefore second communication device 2E sends two messages. Second communication device 2D will also transmit a ‘last message’ being ‘last message 2D’. Analogue to second communication device 2E, second communication device 2D receives ‘last message 2E’ and ‘last message 2F’, which are both transmitted such that second communication device 2D sends three messages. First communication device 1 receives all messages for transmission to the server 6, and transmits its own ‘last message’. This makes clear that even in a short segment of a hopping network, a multitude of messages is generated and transmitted in case of a power cutoff. In the specific example of FIG. 6a, 10 messages or data packets are transmitted and re-transmitted substantially at the same time or at least in a short period of time.

FIG. 6b illustrates a communication path between a second communication device 2F and the remote server 6 which is the same as FIG. 6a. In FIG. 6b, the operation of the second communication devices is based on the hopping distance. This allows to control actions executed in the second communication devices based on the hopping distance. In the example of FIG. 6b, the second communication devices with an uneven hopping distance, being the device 2E, as well as the first communication device 1, are configured to listen for a predetermined time for received messages and, in a further step, configured to combine the messages received during listening with their own last message. As a result, second communication device 2E receives a ‘last message 2F’ and combines its own ‘last message 2E’ with the received ‘last message 2F’ into a single message which is transmitted to second communication device 2D. Second communication device 2D sends its ‘last message 2D’ to the first communication device 1. Furthermore, its transmits the combined ‘last message 2E and 2F’ to the first communication device 1 such that the second communication device 2D sends two messages to the first communication device 1. The first communication device 1 receives the ‘last message 2D’ from the second communication device 2D. The first communication device 1 combines this ‘last message 2D’ with its own last message into a combined single message to the server 6. Furthermore, its transmits the combined ‘last message 2E and 2F’ received from the second communication device 2D to the server 6 such that the first communication device 1 sends two messages to the server 6. In comparison with FIG. 6a, it is evident that significantly less messages are transmitted. Alternatively, the first communication device 1 combines messages 2D+2E+2F in a first message to the server 6, and transmits its own message separately.

FIGS. 6c and 6d show further embodiments illustrating how the operation of the communication devices may be based on the hopping distance. Both FIGS. 6c and 6d show six second communication devices 2G-2L, and a single first communication device 1. The skilled person recognizes from the figure, in analogy to the explanation given above with respect to FIGS. 6a and 6b, that the hopping distance increases from zero for communication device 2G to five for communication device 2L.

In FIG. 6c, the sending and transmitting of messages is based on the hopping distance by providing different transmission slots to different communication devices. Particularly, communication is allowed or enabled alternately between second communication devices with an even hopping distance and with an uneven hopping distance. The consecutive timeslots are illustrated in FIGS. 6c and 6d with consecutive reference numbers 20-26. FIG. 6d differs from FIG. 6c in that the consecutive timeslots are differently assigned to the communication devices. In particular, the second communication devices 2G-2L are divided in trios and different communication devices in the trio are assigned to different timeslots. Based on the illustration in FIGS. 6c and 6d, the skilled person realizes that an optimal balance may be obtained between on the one hand the number of messages transmitted when a power cutoff situation occurs and on the other hand the size of the messages transmitted. Multiple solutions may be proposed wherein the sending and transmitting of messages is based on the hopping distance.

FIG. 6 shows only a single communication path. Hopping mechanisms typically comprise a three structure such that the effect in practice is significantly larger. It is also noted that listening for messages consumes considerably less energy than transmitting messages. Therefore, from energy management point of view, it is advantageous to configure at least some devices in the network, depending on the hopping distance, to listen for messages.

Further mechanisms can be provided to optimize the operation of the network. For example, while listening for messages, messages received are stored in a buffer at the respective communication device. Furthermore, a selection can be made by the receiving communication device to only store those messages which are intended to be transmitted by the communication device. This avoids unnecessary storage of data. In the communication device, the buffer usage can be monitored and, when the buffer usage is above a predetermined threshold, a combined message is transmitted even when the listening period has not been completed or finished. This avoids that messages become too big. This also avoids that messages are dropped because of lack of buffer space.

The actions to be executed by the communication devices in power cutoff mode may be made dependent on the hopping distance in many different ways. Above, a first embodiment is described wherein the listening time of the second communication devices 2 with an even hopping distance is different from the listening time of the second communication devices 2 with an uneven hopping distance. In another embodiment, the listening time of the second communication devices can be made inversely proportional to the hopping distance. The inversely proportional listening may be implemented in a static or dynamic manner. When the action of listening is implemented in all devices in the same way, wherein the listening time is encoded as a formula or algorithm wherein the hopping distance is a factor, the listening action is dynamically made proportional to the hopping distance. Alternatively, the remote server could, when installing the network, provide instructions to the communication device to listen for a predetermined period of time. This predetermined period of time may be chosen by the remote server based on knowledge of the local network, including knowledge of the hopping distance of the particular communication device. The latter would be a static implementation.

Other actions may be implemented based on the hopping distance or actions may be differently executed based on the hopping distance. For example, sequence of actions may be different based on the hopping distance while the actions itself remain identical.

Whilst the principles of the invention have been set out above in connection with specific embodiments, it is to be understood that this description is merely made by way of example and not as a limitation of the scope of protection which is determined by the appended claims.

### LIST OF REFERENCES

1. first communication device
2. second communication device
3. local network
4. short-distance communication module
5. long-distance communication module
6. remote server communication module
7. first energy storage module
8. second energy storage module
9. external power supply
10. driver
11. lamp
12. housing
13. socket
14. controller
15. power+communication
16. communication
17. power
18. zone
19. input-output
20-26. consecutive timeslots
100-104. instructions
105-111. status update
112: power cutoff
113-119: last message
120: period of time
121-124: shutoff
125: status request
126: operator

1. A set of devices adapted to form a local network, the set comprising at least one first communication device and multiple second communication devices, wherein the first and the second communication devices comprise a communication module to communicate in the local network via a hopping mechanism, wherein the first communication device additionally comprises a further communication module to communicate with a remote server, wherein each one of the second communication devices comprises a memory adapted to store a hopping distance to the first communication device, and wherein the second communication device is configured to execute actions based on said hopping distance.

2. The set of devices according to claim 1, wherein the second communication devices comprise a power cutoff detection module, wherein each one of the second communication devices comprises an energy storage module, wherein each second communication device is configured to operate in a power cutoff mode, using energy from the energy storage module, when the power cutoff detection module detects a power cutoff, and wherein the second communication device is configured to execute actions based on said hopping distance in said power cutoff mode.

3. The set of devices according to claim 1, wherein said memory is adapted to store, for different hopping distances, corresponding different parameters for said actions.

4. The set of devices according to claim 1, wherein said actions comprise a sequence of:
receiving a message from a downstream second communication device for transmission to the first communication device; and
transmitting the received message upstream.

5. The set of devices according to claim 4, wherein said actions further comprise receiving a further message from a further downstream second communication device for transmission to the first communication device and merging said message and said further message into a single merged message, and wherein the step of transmitting the received message upstream is comprised by transmitting said single merged message.

6. The set of devices according to claim 4, wherein the step of transmitting is delayed based on said hopping distance.

7. The set of devices according to claim 6, wherein the different parameters comprise at least a delay time for delaying the step of transmitting.

8. The set of devices according to claim 2, wherein said actions further comprise sending a message indicative for the power cutoff.

9. The set of devices according to claim 8, wherein the sending a message indicative for the power cutoff and the transmitting of the received message is combined, and
wherein said actions comprise a sequence of:
receiving a message from a downstream second communication device for transmission to the first communication device; and
transmitting the received message upstream.

10. The set of devices according to claim 1, wherein said first communication device comprises a further power cutoff detection module and a further energy storage module.

11. The set of devices according to claim 1, wherein the local network is an outdoor luminaire network, and wherein at least one of the first and second communication devices serves as communication device for a corresponding luminaire.

12. The set of devices according to claim 1, wherein the communication module is a short-range communication module.

13. The set of devices according to claim 1, wherein the further communication module is a long-distance communication module.

14. A method for operating a communication device in a local network via a hopping mechanism using a communication module, the method comprising:
storing a hopping distance to a predetermined other communication device in the local network; and
operating the communication device, wherein actions are executed based on the stored hopping distance.

15. The method according to claim 14, further comprising:
detecting a power cutoff via a power cutoff detection module, wherein the step of operating comprises operating the communication device in a power cutoff mode, and wherein said actions are executed using energy from an energy storage module.

16. The method according to claim 14, wherein the operating comprises:
receiving a message from a downstream communication device for transmission to an upstream communication device; and
transmitting the received message upstream.

17. The method according to claim 16, wherein the step of transmitting is delayed based on said hopping distance.

18. The method according to claim 17, wherein the step of transmitting further comprises grouping one or multiple received messages into a single message to be transmitted upstream.

19. A communication device comprising a communication module to communicate in a local network via a hopping mechanism, the communication device further comprising a memory, wherein the memory is adapted to store a hopping distance to a predetermined communication device in the network, and wherein the communication device is configured to execute actions based on said hopping distance.

20. The communication device according to claim 19, further comprising a power cutoff detection module and an energy storage module, wherein the communication device is adapted to operate in a power cutoff mode using energy in the energy storage module when the power cutoff detection module detects a power cutoff, and wherein the power cutoff mode comprises said actions based on said hopping distance.
